(19) United States
(12) Patent Application Publication
(10) Pub. No.: US 2026/0299136 A1
(43) Pub. Date: Oct. 1, 2026

(54) ABNORMALITY DIAGNOSIS DEVICE, ABNORMALITY DIAGNOSIS METHOD, AND STORAGE MEDIUM

(71) Applicant: TOYOTA JIDOSHA KABUSHIKI KAISHA, Toyota-shi (JP)

(72) Inventor: Tadashi OKUBO, Tokyo (JP)

(73) Assignee: TOYOTA JIDOSHA KABUSHIKI KAISHA, Toyota-shi (JP)

(21) Appl. No.: 19/548,186

(22) Filed: Feb. 24, 2026

(30) Foreign Application Priority Data
Apr. 1, 2025 (JP) 2025-060795

(51) Int. Cl. G01S 19/39; G01S 19/47

(52) U.S. Cl. CPC G01S 19/396; G01S 19/47

(57) ABSTRACT

The abnormality diagnosis device includes a self-position estimation unit that calculates a change amount of an estimated self-position of the vehicle based on an output of a GNSS receiver, a first movement amount calculation unit that calculates a movement amount of the vehicle in the lateral direction based on an output of a LiDAR, a second movement amount calculation unit that calculates a movement amount of the vehicle in the longitudinal direction based on an output of a camera, and an abnormality detection unit that detects an abnormality of the self-position estimation of the vehicle. The abnormality detection unit detects the abnormality of the self-position estimation of the vehicle by comparing the change amount of the estimated self-position with the estimated movement amount of the vehicle obtained from the movement amount in the horizontal direction and the movement amount in the vertical direction.

### CROSS-REFERENCE TO RELATED APPLICATION

This application claims priority to Japanese Patent Application No. 2025-060795 filed on Apr. 1, 2025. The disclosure of the above-identified application, including the specification, drawings, and claims, is incorporated by reference herein in its entirety.

### BACKGROUND

### 1. Technical Field

The present disclosure relates to an abnormality diagnosis device, an abnormality diagnosis method, and a storage medium.

### 2. Description of Related Art

Japanese Patent No. 6671152 describes providing a vehicle such as a dump truck with a front LiDAR and a rear LiDAR. Japanese Patent No. 6671152 describes detecting whether there is an abnormality in the self-position of the vehicle calculated by a self-position estimation device based on GPS positioning data using the outputs of the front LiDAR and the rear LiDAR.

### SUMMARY

In the above technique, an abnormality in self-position estimation is diagnosed based on whether a road shoulder feature point detected based on the output of the rear LiDAR is located on the track of a road shoulder feature point detected based on the output of the front LiDAR. In this case, even when an abnormality in self-position estimation in the lateral direction of the vehicle can be detected according to the amount of deviation from the track, it is difficult to detect an abnormality in self-position estimation in the longitudinal direction (traveling direction) of the vehicle.

In view of the above issue, an object of the present disclosure is to improve the accuracy in diagnosing an abnormality in estimation of the self-position of a vehicle.

An overview of the present disclosure is as follows.

(1) An abnormality diagnosis device including:
a self-position estimation unit that calculates an amount of change in an estimated self-position of a vehicle based on an output of a GNSS receiver provided in the vehicle;
a first movement amount calculation unit that calculates an amount of movement of the vehicle based on an output of a LiDAR provided in the vehicle;
a second movement amount calculation unit that calculates an amount of movement of the vehicle based on an output of a camera provided in the vehicle; and
an abnormality detection unit that detects an abnormality in the estimated self-position of the vehicle, in which:
the first movement amount calculation unit calculates an amount of lateral movement of the vehicle, and the second movement amount calculation unit calculates an amount of longitudinal movement of the vehicle; and
the abnormality detection unit detects the abnormality in the estimated self-position of the vehicle by comparing the amount of change in the estimated self-position and an estimated amount of movement of the vehicle obtained from the amount of lateral movement and the amount of longitudinal movement.

(2) The abnormality diagnosis device according to (1) above, in which:
the first movement amount calculation unit calculates the amount of movement of the vehicle based on the output of the LiDAR and an output of an IMU provided in the vehicle; and
the second movement amount calculation unit calculates the amount of movement of the vehicle based on the output of the camera and the output of the IMU.

(3) The abnormality diagnosis device according to (1) or (2) above, in which:
the first movement amount calculation unit calculates the amount of lateral movement and the amount of longitudinal movement; and
the abnormality detection unit detects the abnormality by comparing the amount of change in the estimated self-position and an estimated amount of movement of the vehicle obtained from the amount of lateral movement calculated by the first movement amount calculation unit and the amount of longitudinal movement calculated by the second movement amount calculation unit when the amount of longitudinal movement calculated by the first movement amount calculation unit is less than a predetermined value, and detects the abnormality by comparing the amount of change in the estimated self-position and an estimated amount of movement of the vehicle obtained from the amount of lateral movement and the amount of longitudinal movement calculated by the first movement amount calculation unit when the amount of longitudinal movement calculated by the first movement amount calculation unit is equal to or more than the predetermined value.

(4) An abnormality diagnosis method executed by a computer, the abnormality diagnosis method including:
calculating an amount of change in an estimated self-position of a vehicle based on an output of a GNSS receiver provided in the vehicle;
calculating an amount of lateral movement of the vehicle based on an output of a LiDAR provided in the vehicle;
calculating an amount of longitudinal movement of the vehicle based on an output of a camera provided in the vehicle; and
detecting an abnormality in the estimated self-position of the vehicle by comparing the amount of change in the estimated self-position and an estimated amount of movement of the vehicle obtained from the amount of lateral movement and the amount of longitudinal movement.

(5) A storage medium storing a computer program causing a computer to execute a process including:
calculating an amount of change in an estimated self-position of a vehicle based on an output of a GNSS receiver provided in the vehicle;
calculating an amount of lateral movement of the vehicle based on an output of a LiDAR provided in the vehicle;
calculating an amount of longitudinal movement of the vehicle based on an output of a camera provided in the vehicle; and
detecting an abnormality in the estimated self-position of the vehicle by comparing the amount of change in the estimated self-position and an estimated amount of movement of the vehicle obtained from the amount of lateral movement and the amount of longitudinal movement.

According to the present disclosure, it is possible to improve the accuracy in diagnosing an abnormality in estimation of the self-position of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an abnormality diagnosis system including an abnormality diagnosis device according to a first embodiment of the present disclosure;

FIG. 2 is a functional diagram of a processor of an ECU;

FIG. 3 is a diagram schematically illustrating a state in which a deviation occurs in an estimation result of a self-position of a vehicle;

FIG. 4 is a flowchart illustrating a control routine related to an abnormality diagnosis process according to the first embodiment;

FIG. 5 is a flowchart showing a control routine related to an anomaly diagnosing process according to the second embodiment; and

FIG. 6 is a flowchart illustrating a control routine related to an abnormality diagnosis process in the third embodiment.

### DETAILED DESCRIPTION OF EMBODIMENTS

Hereinafter, an embodiment of the disclosure will be described with reference to drawings. In the following description, similar components are given the same reference numbers.

### First Embodiment

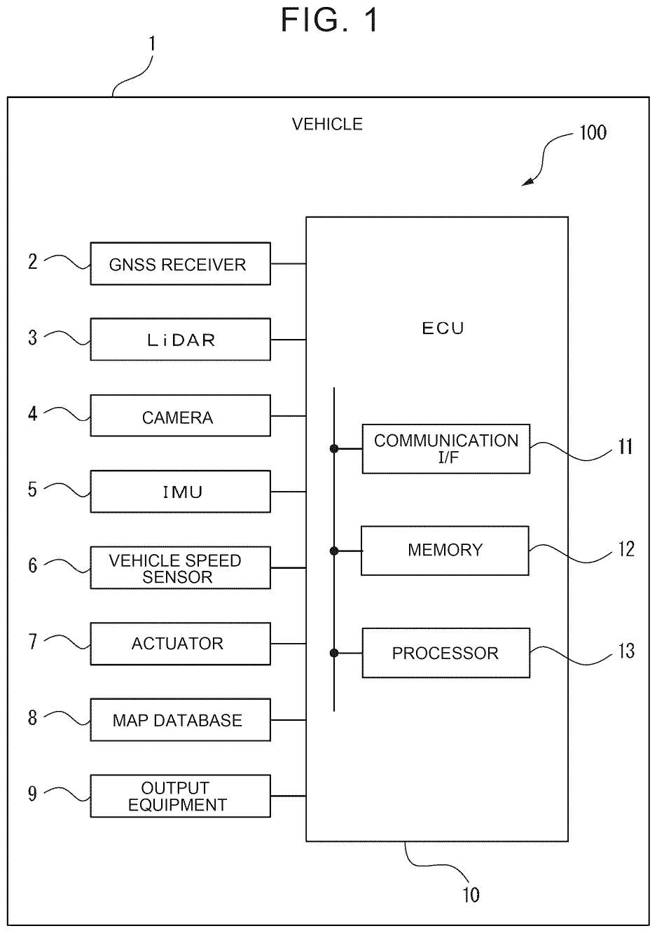

Hereinafter, a first embodiment of the present disclosure will be described with reference to FIGS. 1 to 4. FIG. 1 is a schematic configuration diagram of an abnormality diagnosis system 100 including an abnormality diagnosis device according to a first embodiment of the present disclosure. The abnormality diagnosis system 100 is mounted on the vehicle 1 and performs abnormality diagnosis of self-position estimation of the vehicle 1. In the present embodiment, the vehicle 1 is a four-wheeled vehicle.

As illustrated in FIG. 1, the abnormality diagnosis system 100 includes a GNSS receiver 2, a LiDAR (Laser Imaging Detection And Ranging) 3, a camera 4, an inertial measurement device (IMU: Inertial Measurement Unit) 5, a vehicle speed sensor 6, an actuator 7, a map database 8, an output device 9, and an electronic control unit (ECU: Electronic Control Unit) 10. That is, GNSS receiver 2, LiDAR 3, the camera 4, IMU 5, the vehicle speed sensor 6, the actuator 7, the map database 8, the output device 9, and ECU 10 are provided in the vehicle 1. GNSS receiver 2, LiDAR 3, the camera 4, IMU 5, the vehicle speed sensor 6, the actuator 7, the map database 8, and the output device 9 are electrically connected to ECU 10 via an in-vehicle network or the like compliant with a standard such as CAN (Controller Area Network) or Ethernet (Ethernet).

GNSS receiver 2 measures the position of the vehicle 1 and generates the position of the vehicle 1. Specifically, GNSS receiver 2 detects the present position of the vehicle 1 (for example, the latitude, longitude, and altitude of the vehicle 1) based on positioning information obtained from a plurality of (for example, three or more) positioning satellites. GNSS receivers are exemplified by GPS (Global Positioning System) receivers. The power of GNSS receiver 2, i.e. the present position of the vehicles 1 detected by GNSS receiver 2, is transmitted to ECU 10.

LiDAR 3 irradiates the periphery of the vehicle 1 with laser light and receives reflected light of the laser light. Then, LiDAR 3 generates point cloud data representing a feature around the vehicle 1 on the basis of the reflected light of the laser beam. The point cloud data includes information such as a distance, a reflection intensity, and an irradiation angle of each reflection point. For example, LiDAR 3 is arranged in a front part of the vehicle 1 (for example, a front bumper of the vehicle 1) and detects features in front and in front of the vehicle 1. The outputting of LiDAR 3, i.e. the point cloud generated by LiDAR 3, is transmitted to ECU 10.

The camera 4 photographs the periphery of the vehicle 1 to generate a peripheral image of the vehicle 1. For example, the camera 4 is disposed at a front portion of the vehicle 1 (for example, a front bumper of the vehicle 1, a rear surface of a room mirror in a vehicle cabin, or the like), and generates images of the front and front sides of the vehicle 1. The camera 4 may be a monocular camera or a stereo camera. The output of the camera 4, i.e. the surrounding images generated by the camera 4, is transmitted to ECU 10.

IMU 5 includes a three-axis gyro sensor that detects an angular velocity in a three-axis direction and a three-axis acceleration sensor that detects an acceleration in a three-axis direction in order to detect a dynamical behavior of the vehicle 1. With this configuration, IMU 5 can sample the attitude change, the turning operation, and the acceleration/deceleration operation of the vehicle 1 at a high frequency. For example, IMU 5 is arranged near the center of gravity of the vehicle 1. IMU 5 power, i.e. the triaxial angular velocity and acceleration detected by IMU 5, is transmitted to ECU 10.

The vehicle speed sensor 6 detects the speed of the vehicle 1. For example, the vehicle speed sensor 6 detects the speed of the vehicle 1 by detecting the rotational speed of the wheels of the vehicle 1. The vehicle speed sensor 6 outputs, that is, the speed of the vehicle 1 detected by the vehicle speed sensor 6 is transmitted to ECU 10.

The actuator 7 operates the vehicle 1 in response to an instruction from ECU 10.

The actuator 7 includes a drive actuator, a braking actuator, and a steering actuator. The drive actuator controls acceleration of the vehicle 1 via a drive device of the vehicle 1 (for example, an internal combustion engine, an electric motor, or a hybrid configuration of both). The braking actuator controls braking of the vehicle 1 via a braking system of the vehicle 1. The steering actuator controls the steering of the vehicle 1 via a steering system of the vehicle 1. In the present embodiment, ECU 10 controls the behavior of the vehicle 1 (for example, acceleration, braking, and steering of the vehicle 1) using the actuator 7. That is, the vehicle 1 is an autonomous vehicle in which acceleration, braking, and steering of the vehicle 1 are automatically controlled.

The map database 8 stores map information. The map information includes, for example, road position information, road shape information (for example, a type of a curve and a straight portion, a curvature of a curve, a road gradient, and the like), road information such as a road type and a restricted vehicle speed. Note that the map database 8 may be provided outside the vehicle 1 (e.g., servers, etc.), and ECU 10 may acquire the map data from outside the vehicle 1.

The output device 9 notifies an occupant (for example, a driver) of the vehicle 1. The output device 9 includes at least one of a display, a warning light, a speaker, a buzzer, and a vibration unit. The output device 9 notifies the occupant of the vehicle 1 of an output corresponding to the signal transmitted from ECU 10.

ECU 10 executes various controls of the vehicles 1. As shown in FIG. 1, ECU 10 includes a communication interface 11, a memory 12, and a processor 13. The communication interface 11 and the memory 12 are connected to the processor 13 via a signal line. In the present embodiment, one ECU 10 is provided, but a plurality of ECU may be provided for each function. In addition, the communication interface 11, the memory 12, and the processor 13 may be configured as one integrated circuit, or may be configured as separate circuits.

The communication interface 11 has interface circuitry for connecting ECU 10 to the in-vehicle networking. ECU 10 is connected to other in-vehicle devices via the communication interface 11. The communication interface 11 transmits signals received from GNSS receiver 2, LiDAR 3, the camera 4, IMU 5, the vehicle speed sensor 6, and the map database 8 to the processor 13. The communication interface 11 transmits the signal output from the processor 13 to the actuator 7 and the output device 9.

The memory 12 includes, for example, volatile semiconductor memories (e.g.,

DRAM (Dynamic Random Access Memory), SRAM (Static Random Access Memory), and the like), and non-volatile semiconductor memories (e.g., ROM (Read Only Memory), EEPROM (Electrically Erasable Programmable Read Only Memory), flash memories, and the like). The memory 12 stores temporary data, a computer program (an ECU 10 control program) used for various processes by the processor 13, ECU 10 setting data, log data, vehicle-information, and the like.

The processor 13 comprises one or more CPU (Central Processing Unit) and its peripheral circuitry. The processor 13 executes a computer program stored in the memory 12. The processor 13 may further include other arithmetic circuits such as a logical arithmetic unit, a numerical arithmetic unit, or a graphic processing unit.

In the present embodiment, ECU 10 functions as an abnormality diagnosis device that performs abnormality diagnosis of self-position estimation of the vehicles 1. ECU 10 is an exemplary abnormality diagnosis device.

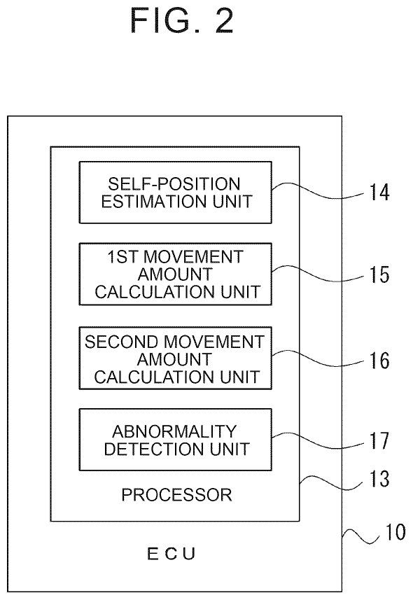

FIG. 2 is a functional diagram of the processor 13 of ECU 10. As illustrated in FIG. 2, the processor 13 includes a self-position estimation unit 14, a first movement amount calculation unit 15, a second movement amount calculation unit 16, and an abnormality detection unit 17. The self-position estimation unit 14, the first movement amount calculation unit 15, the second movement amount calculation unit 16, and the abnormality detection unit 17 are functional modules realized by ECU 10 processor 13 executing a computer program stored in ECU 10 memory 12. These functional modules may be realized by dedicated arithmetic circuits provided in the processor 13.

The self-position estimation unit 14 estimates the self-position of the vehicle 1. In the present embodiment, the self-position estimation unit 14 acquires the self-estimated position of the vehicle 1 based on the power of GNSS receiver 2. In the present embodiment, the self-estimated position of the vehicle 1 is used for control for automated driving of the vehicle 1. For example, ECU 10 generates a travel route of the vehicle 1 based on the self-estimated position of the vehicle 1.

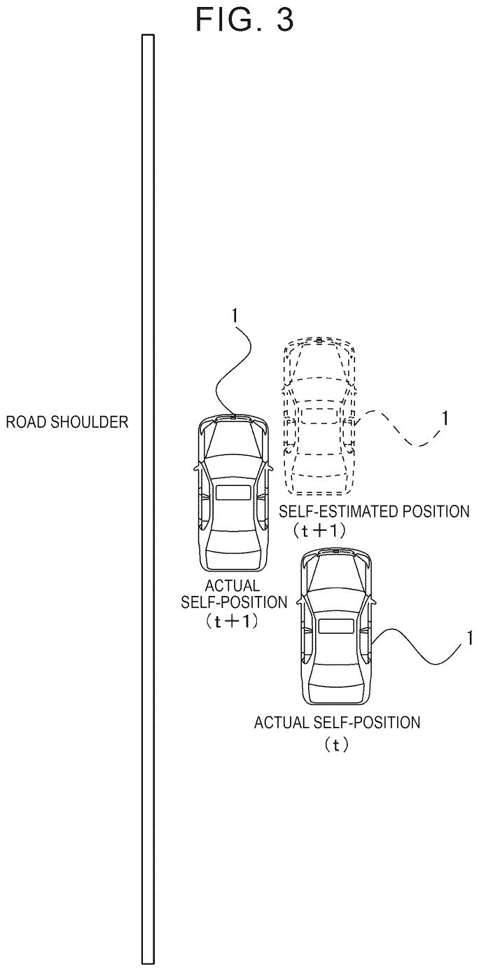

FIG. 3 is a diagram schematically illustrating a state in which a deviation occurs in an estimation result of the self position of the vehicle 1. In FIG. 3, the actual self-position of the vehicle 1 at the time t and the time t+1 is indicated by a solid line, and the self-estimated position of the vehicle 1 at the time t+1 is indicated by a broken line. In the example of FIG. 3, at time t+1, a deviation occurs between the actual self-position of the vehicle 1 and the self-estimated position of the vehicle 1. This deviation is caused by the influence of multipath, clock error, radio interference, and the like.

When a deviation occurs between the actual self-position and the self-estimated position, it becomes difficult to continue the automated driving of the vehicle 1. Therefore, in the vehicle 1, it is desirable to be able to diagnose an abnormality of the self-position estimation of the vehicle 1. For example, it is conceivable to perform anomaly diagnosis of self-position estimation by comparing the amount of change in the self-estimated position of the vehicle 1 calculated based on GNSS receiver 2 with the amount of travel of the vehicle 1 calculated based on LiDAR 3.

However, in the point cloud generated by LiDAR 3, the vertical resolution of the vehicle 1 is usually lower than the horizontal resolution of the vehicle 1. In addition, unlike the camera 4, LiDAR 3 cannot acquire detailed texture information. Therefore, in the above-described method, even when the deviation of the self-estimated position in the lateral direction of the vehicle 1 can be detected, it is difficult to detect the deviation of the self-estimated position in the longitudinal direction of the vehicle 1. This is particularly pronounced when only a feature (for example, a road shoulder (see FIG. 3), a bank, or the like) having a small shape change in the longitudinal direction of the vehicle 1 is present in the vicinity of the vehicle 1. In this specification, the vertical direction of the vehicle 1 means a traveling direction of the vehicle 1 (vertical direction in FIG. 3), and the horizontal direction of the vehicle 1 means a direction perpendicular to the traveling direction of the vehicle 1 (left-right direction in FIG. 3).

In view of the above, in the present embodiment, an anomaly diagnosis of the self-position estimation of the vehicle 1 is performed by calculating the travel distance of the vehicle 1 using not only LiDAR 3 but also the cameras 4. As a result, it is possible to improve the accuracy of the abnormality diagnosis of the self-position estimation of the vehicle 1. Hereinafter, specific control will be described.

The self-position estimation unit 14 calculates a change amount of the self-estimated position of the vehicle 1 (hereinafter, simply referred to as a “change amount of the self-estimated position”) based on the output of GNSS receiver 2. The self-position estimation unit 14 calculates the amount of change in the self-estimated position at a predetermined time interval. For example, the self-position estimation unit 14 acquires the self-estimated positions at time t and time t=1 based on the output of GNSS receiver 2, and calculates the differences between the self-estimated positions as the variation of the self-estimated positions.

On the other hand, the first movement amount calculation unit 15 calculates the movement amount of the vehicle 1 based on the output of LiDAR 3, and the second movement amount calculation unit 16 calculates the movement amount of the vehicle 1 based on the output of the camera 4. Here, the first movement amount calculation unit 15 is also referred to as a LiDAR odometry calculation unit, and the second movement amount calculation unit 16 is also referred to as a camera odometry calculation unit.

In particular, in the present embodiment, the first movement amount calculation unit 15 calculates the movement amount in the lateral direction of the vehicle 1 based on the output of LiDAR 3, and the second movement amount calculation unit 16 calculates the movement amount in the vertical direction of the vehicle 1 based on the output of the camera 4. By using LiDAR 3 and the camera 4 in combination, it is possible to compensate for the disadvantages of LiDAR 3 and the camera 4, and in turn, it is possible to accurately calculate the longitudinal and lateral movements of the vehicle 1.

The first movement amount calculation unit 15 calculates a lateral movement amount of the vehicle 1 at a predetermined time interval. For example, the first movement amount calculation unit 15 calculates the lateral movement amount of the vehicle 1 between the time t and the time t+1. The second movement amount calculation unit 16 calculates a movement amount of the vehicle 1 in the vertical direction at a predetermined time interval. For example, the second movement amount calculation unit 16 calculates the movement amount in the vertical direction of the vehicle 1 between the time t and the time t+1.

The abnormality detection unit 17 detects an abnormality of the self-position estimation of the vehicle 1 by comparing the change amount of the self-estimated position with the estimated movement amount of the vehicle 1. The change amount of the self-estimated position is calculated by the self-position estimation unit 14. The estimated movement amount of the vehicle 1 is obtained from the lateral movement amount of the vehicle 1 calculated by the first movement amount calculation unit 15 and the vertical movement amount of the vehicle 1 calculated by the second movement amount calculation unit 16. For example, the abnormality detection unit 17 determines that the self-position estimation of the vehicle 1 is abnormal when the difference between the change amount of the self-estimated position and the estimated movement amount of the vehicle 1 is equal to or greater than a predetermined threshold, and determines that the self-position estimation of the vehicle 1 is normal when the difference is less than the threshold.

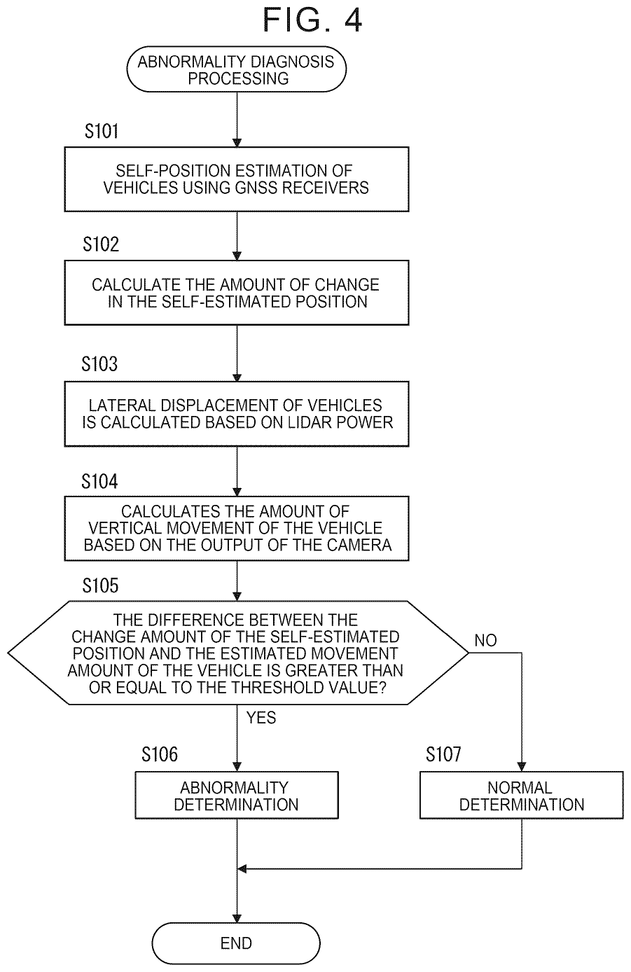

Hereinafter, a flow of the above-described processing for executing the control will be described with reference to the flowchart of FIG. 4. FIG. 4 is a flowchart illustrating a control routine related to the abnormality diagnosis process in the first embodiment. The control routine is repeatedly executed by the processor 13 of ECU 10 at predetermined runtime intervals, for example, in accordance with a computer program stored in the memory 12 of ECU 10.

First, in S101, the self-position estimation unit 14 of the processor 13 estimates the self-position of the vehicles 1 using GNSS receiver 2. Specifically, the self-position estimation unit 14 acquires the self-estimated position of the vehicle 1 based on the power of GNSS receiver 2.

Next, in S102, the self-position estimation unit 14 calculates the variation of the self-estimated position of the vehicle 1 at a predetermined time-interval. For example, the predetermined time interval is an execution interval of the present control routine. For example, the self-position estimation unit 14 calculates the difference between the self-estimated position acquired in S101 of the current control routine and the self-estimated position acquired in S101 of the previous control routine as the variation of the self-estimated position.

Next, in S103, the first movement amount calculation unit 15 of the processor 13 calculates the lateral movement amount of the vehicle 1 at the predetermined time-interval based on LiDAR 3. When the predetermined time interval is a time interval between the time t and the time t+1, the first movement amount calculation unit 15 compares the point cloud data generated by LiDAR 3 at the time t with the point cloud data generated by LiDAR 3 at the time t+1. Thus, the first movement amount calculation unit 15 calculates the movement amount of the vehicle 1 in the lateral direction. The point cloud data at time t is point cloud data in the previous frame, and the point cloud data at time t+1 is point cloud data in the current frame.

For example, the first movement amount calculation unit 15 calculates the lateral movement amount of the vehicles 1 by using LiDAR odometry method. Specifically, the first movement amount calculation unit 15 calculates the lateral movement amount of the vehicle 1 by matching the feature points of the point cloud data between the previous and subsequent frames and calculating the coordinate transformation parameters (for example, coordinate transformation matrices) of the two point cloud data. The first movement amount calculation unit 15 may use a known algorithm such as ICP (Iterative Closest Point) or NDT (Normal Distributions Transform) when calculating the coordinate transformation parameters. In addition, the first movement amount calculation unit 15 may use a known method such as RANSAC (Random Sample Consensus) or statistical outlier removal (SOR: Statistical Outlier Removal) to remove outliers or noises from the point cloud data.

Next, in S104, the second movement amount calculation unit 16 of the processor 13 calculates the vertical movement amount of the vehicle 1 at the predetermined time-interval based on the output of the camera 4. When the predetermined time interval is a time interval between the time t and the time t+1, the second movement amount calculation unit 16 compares the image generated by the camera 4 at the time t with the image generated by the camera 4 at the time t+1. Thus, the second movement amount calculation unit 16 calculates the movement amount of the vehicle 1 in the vertical direction. The image at time t is an image in the previous frame, and the image at time t+1 is an image in the current frame.

For example, the second movement amount calculation unit 16 calculates the vertical movement amount of the vehicle 1 by using Visual odometry method. Specifically, the second movement amount calculation unit 16 calculates the movement amount in the vertical direction of the vehicle 1 by estimating the ego motion of the camera 4 by matching the feature points of the images between the front and rear frames. The second movement amount calculation unit 16 can use a known method such as nearest neighbor search or k neighbor search when matching feature points of two images. Further, the second movement amount calculation unit 16 can use a known method such as estimation of an essential matrix or estimation of a homography matrix when estimating an ego motion of the camera 4.

Next, in S105, the abnormality detection unit 17 of the processor 13 determines whether or not the difference between the change amount of the self-estimated position and the estimated movement amount of the vehicle 1 obtained from the movement amount in the lateral direction and the movement amount in the vertical direction of the vehicle 1 is equal to or greater than a predetermined threshold. The threshold value is determined in advance in consideration of a desired accuracy or the like of the self-position estimation of the vehicle 1. For example, when at least one of the difference between the lateral movement amount of the self-estimated position and the lateral movement amount of the vehicle 1 and the difference between the longitudinal movement amount of the self-estimated position and the longitudinal movement amount of the vehicle 1 is equal to or larger than the threshold value, the abnormality detection unit 17 determines that the difference between the change amount of the self-estimated position and the estimated movement amount of the vehicle 1 is equal to or larger than the threshold value. Note that the abnormality detection unit 17 may determine that the difference between the change amount of the self-estimated position and the estimated movement amount of the vehicle 1 is equal to or larger than the threshold when both of the two differences are equal to or larger than the threshold. Further, the abnormality detection unit 17 may calculate the change amount of the self-estimated position and the estimated movement amount of the vehicle 1 as vectors, and compare these vectors to determine whether or not the difference between the change amount of the self-estimated position and the estimated movement amount of the vehicle 1 is equal to or larger than a threshold value.

When it is determined in S105 that the difference between the change amount of the self-estimated position and the estimated travel amount of the vehicle 1 is equal to or greater than the threshold value, the present control routine proceeds to S106. In S106, the abnormality detection unit 17 determines that the self-position estimation of the vehicle 1 is abnormal. That is, the abnormality detection unit 17 detects an abnormality of the self-position estimation of the vehicle 1. In this case, for example, the abnormality detection unit 17 notifies the occupant of the vehicle 1 of the abnormality via the output device 9, and stops the vehicle 1 at a safe place such as a road shoulder by using the actuator 7. The abnormality detection unit 17 may request the occupant of the vehicle 1 to switch from automated driving to manual driving (so-called handover) via the output device 9. After S106, the control routine ends.

On the other hand, when it is determined in S105 that the difference between the change amount of the self-estimated position and the estimated travel amount of the vehicle 1 is less than the threshold value, the present control routine proceeds to S107. In S107, the abnormality detection unit 17 determines that the self-position estimation of the vehicle 1 is normal. After S107, the control routine ends.

In S101, the self-position estimation unit 14 may estimate the self-position of the vehicle 1 using at least one of IMU 5 and the vehicle speed sensor 6 in addition to GNSS receiver 2.

### Second Embodiment

The configuration and control of the abnormality diagnosis device according to the second embodiment are basically the same as the configuration and control of the abnormality diagnosis device according to the first embodiment except for the points described below. Therefore, in the following, the second embodiment of the present disclosure will be described focusing on differences from the first embodiment.

In the second embodiment, the first movement amount calculation unit 15 calculates the movement amount of the vehicle 1 based on the output of LiDAR 3 and the output of IMU 5, and the second movement amount calculation unit 16 calculates the movement amount of the vehicle 1 based on the output of the camera 4 and the output of IMU 5. As a result, the amount of movement of the vehicle 1 can be calculated with higher accuracy, and thus the accuracy of the abnormality diagnosis of the self-position estimation of the vehicle 1 can be further improved. In the second embodiment, the first movement amount calculation unit 15 is also referred to as a LiDAR inertial odometry calculation unit, and the second movement amount calculation unit 16 is also referred to as a camera inertial odometry calculation unit.

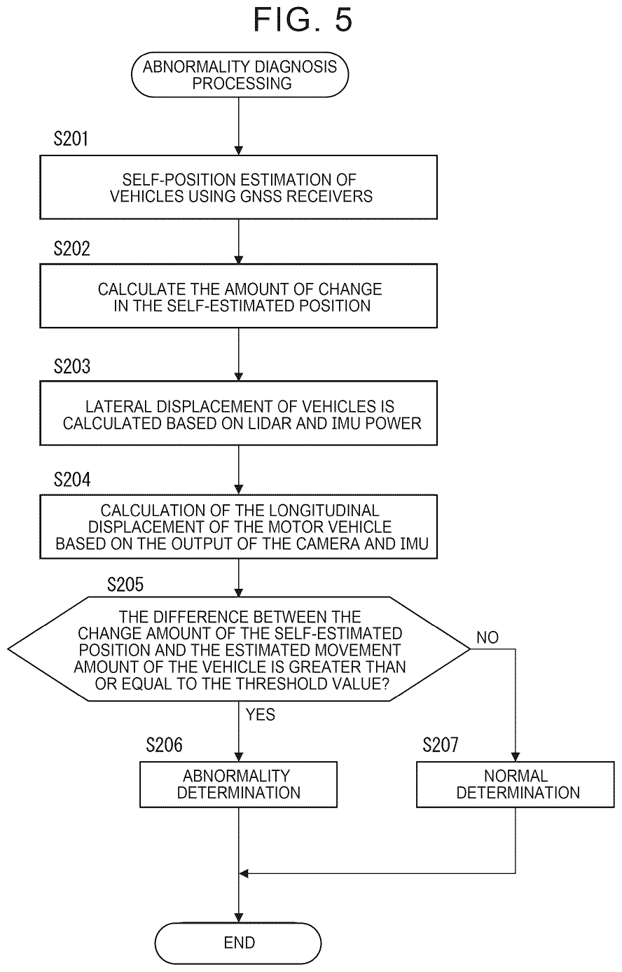

FIG. 5 is a flowchart illustrating a control routine related to an abnormality diagnosis process in the second embodiment. The control routine is repeatedly executed by the processor 13 of ECU 10 at predetermined runtime intervals, for example, in accordance with a computer program stored in the memory 12 of ECU 10.

S201 and S202 are performed in the same manner as S101 and S102 of FIG. 4.

After S202, in S203, the first movement amount calculation unit 15 of the processor 13 calculates the lateral movement amount of the vehicle 1 at a predetermined time interval (for example, a time interval between the time t and the time t+1) based on the output of LiDAR 3 and the output of IMU 5. For example, the first movement amount calculation unit 15 calculates the lateral movement amount of the vehicle 1 by using LiDAR inertial odometry method. That is, the first movement amount calculation unit 15 calculates the lateral movement amount of the vehicles 1 by integrating the output of LiDAR 3 and the output of IMU 5.

For example, the first movement amount calculation unit 15 integrates the output of LiDAR 3 and the output of IMU 5 by a Loosely Coupled method. In this case, the first movement amount calculation unit 15 independently calculates an estimated value based on the output of LiDAR 3 and an estimated value based on the output of IMU 5, and integrates these values by a subsequent filter (for example, a Kalman filter) to calculate a final estimated value. The first movement amount calculation unit 15 may integrate the output of LiDAR 3 and the output of IMU 5 by a Tightly Coupled method. In this case, the first movement amount calculation unit 15 calculates an estimated value by incorporating the output of LiDAR 3 and the output of IMU 5 into the same optimization problem/state estimation framework (for example, nonlinear optimization, factor graph, extended Kalman filter, particle filter, or the like).

Next, in S204, the second movement amount calculation unit 16 of the processor 13 calculates the vertical movement amount of the vehicle 1 at a predetermined time interval (for example, a time interval between the time t and the time t+1) based on the output of the camera 4 and the output of IMU 5. For example, the second movement amount calculation unit 16 calculates the vertical movement amount of the vehicle 1 by using Visual inertial odometry method. That is, the second movement amount calculation unit 16 calculates the vertical movement amount of the vehicle 1 by integrating the output of the camera 4 and the output of IMU 5. For example, the second movement amount calculation unit 16 integrates the output of the camera 4 and the output of IMU 5 by an extended Kalman filter or nonlinear optimization.

After S204, S207 from S205 is performed in the same manner as S107 from S105 of FIG. 4.

### Third Embodiment

The configuration and control of the abnormality diagnosis device according to the third embodiment are basically the same as the configuration and control of the abnormality diagnosis device according to the first embodiment except for the points described below. Therefore, in the following, the third embodiment of the present disclosure will be described focusing on differences from the first embodiment.

In the third embodiment, the first movement amount calculation unit 15 calculates the movement amount in the lateral direction and the movement amount in the vertical direction of the vehicle 1 on the basis of LiDAR 3. When the vertical movement amount calculated by the first movement amount calculation unit 15 is less than the predetermined value, the abnormality detection unit 17 detects the abnormality of the self-estimation of the vehicle 1 by comparing the change amount of the self-estimation position with the estimated movement amount of the vehicle 1. The change amount of the self-estimated position is calculated by the self-position estimation unit 14. The estimated movement amount of the vehicle 1 is obtained from the lateral movement amount calculated by the first movement amount calculation unit 15 and the vertical movement amount calculated by the second movement amount calculation unit 16. On the other hand, when the vertical movement amount calculated by the first movement amount calculation unit 15 is equal to or larger than the predetermined value, the abnormality detection unit 17 compares the change amount of the self-estimated position calculated by the self-position estimation unit 14 with the estimated movement amount of the vehicle 1 obtained from the horizontal movement amount and the vertical movement amount calculated by the first movement amount calculation unit 15. Accordingly, the abnormality detection unit 17 detects an abnormality of the self-estimation of the vehicle 1. As a result, it is possible to accurately diagnose an anomaly in the self-position estimation of the vehicle 1 by effectively using LiDAR 3 and the camera 4 in combination.

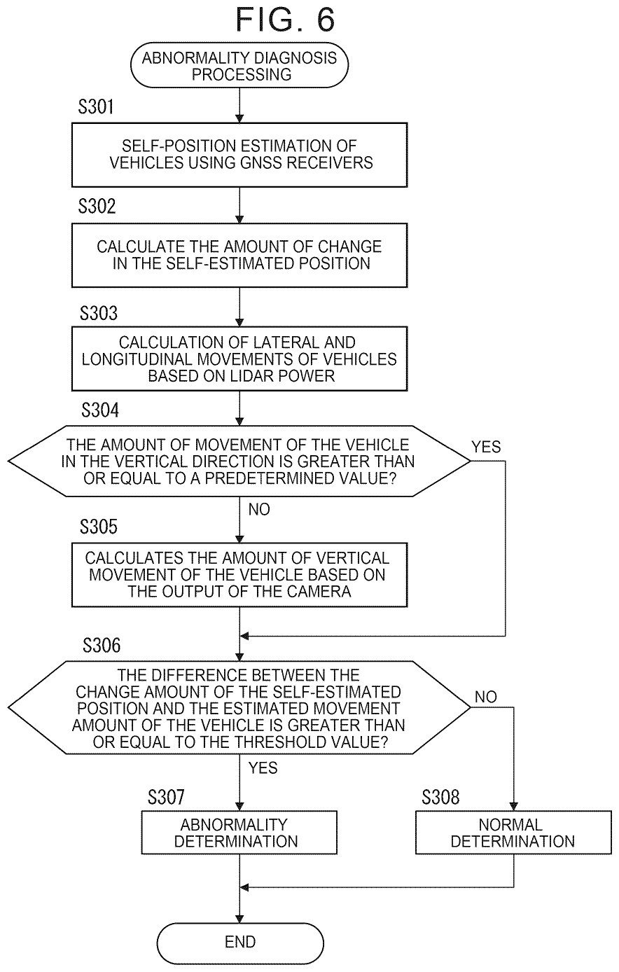

FIG. 6 is a flowchart illustrating a control routine related to an abnormality diagnosis process in the third embodiment. The control routine is repeatedly executed by the processor 13 of ECU 10 at predetermined runtime intervals, for example, in accordance with a computer program stored in the memory 12 of ECU 10.

S301 and S302 are performed in the same manner as S101 and S102 of FIG. 4.

After S302, in S303, the first movement amount calculation unit 15 of the processor 13 calculates the movement amount in the lateral direction and the movement amount in the longitudinal direction of the vehicle 1 at a predetermined time interval (for example, a time interval between the time t and the time t+1) based on the output of LiDAR 3. The method of calculating the amount of movement in the vertical direction is the same as the method of calculating the amount of movement in the horizontal direction described above with respect to S103 of FIG. 4.

Next, in S304, the abnormality detection unit 17 of the processor 13 determines whether or not the vertical movement amount of the vehicle 1 calculated by the first movement amount calculation unit 15 is equal to or greater than a predetermined value. When it is determined that the vertical movement of the vehicle 1 is less than the predetermined value, the present control routine proceeds to S305. S308 from S305 is performed in the same manner as S107 from S104 of FIG. 4.

On the other hand, when S304 determines that the vertical displacement of the vehicle 1 is equal to or greater than a predetermined value, the present control routine proceeds to S306. In S306, the abnormality detection unit 17 determines whether or not the difference between the change amount of the self-estimated position calculated by the self-position estimation unit 14 and the estimated movement amount of the vehicle 1 is equal to or greater than a predetermined threshold. The estimated movement amount is obtained from the lateral movement amount and the longitudinal movement amount calculated by the first movement amount calculation unit 15. The method of determination is similar to the method described above with respect to S105 of FIG. 4.

When it is determined in S306 that the difference between the change amount of the self-estimated position and the estimated travel amount of the vehicle 1 is equal to or greater than the threshold value, the present control routine proceeds to S307. In S307, as in S106 of FIG. 4, the abnormality detection unit 17 determines that the self-position estimation of the vehicle 1 is abnormal. After S307, the control routine ends.

On the other hand, when it is determined in S306 that the difference between the change amount of the self-estimated position and the estimated travel amount of the vehicle 1 is less than the threshold value, the present control routine proceeds to S308. In S308, the abnormality detection unit 17 determines that the self-position estimation of the vehicle 1 is normal. After S308, the control routine ends.

### Other Embodiments

Although the preferred embodiments of the present disclosure have been described above, the present disclosure is not limited to these embodiments, and various modifications and changes can be made within the scope of the claims.

For example, a server or the like provided outside the vehicle 1 and capable of communicating with the vehicle 1 may function as an abnormality diagnosis device. In this case, information necessary for executing the above-described control is transmitted from the vehicle 1 to the server.

Further, the second embodiment and the third embodiment can be implemented in combination. In S303 of the control routine of the anomaly diagnosis process of FIG. 6, the first movement amount calculation unit 15 calculates the movement amount in the horizontal direction and the vertical direction of the vehicle 1 based on the output of LiDAR 3 and the output of IMU 5. Further, in S305, the second movement amount calculation unit 16 calculates the vertical movement amount of the vehicle 1 based on the output of the camera 4 and the output of IMU 5.

In addition, a computer program that causes a computer to realize the functions of the processors 13 of ECU 10 or the units included in the processors of the servers may be provided in a form stored in a computer-readable recording medium or a form included in a computer program product. The computer-readable recording medium is, for example, a magnetic recording medium, an optical recording medium, or a semiconductor memory.

What is claimed is:

1. An abnormality diagnosis device comprising:
a self-position estimation unit that calculates an amount of change in an estimated self-position of a vehicle based on an output of a GNSS receiver provided in the vehicle;
a first movement amount calculation unit that calculates an amount of movement of the vehicle based on an output of a LiDAR provided in the vehicle;
a second movement amount calculation unit that calculates an amount of movement of the vehicle based on an output of a camera provided in the vehicle; and
an abnormality detection unit that detects an abnormality in the estimated self-position of the vehicle, wherein:
the first movement amount calculation unit calculates an amount of lateral movement of the vehicle, and the second movement amount calculation unit calculates an amount of longitudinal movement of the vehicle; and
the abnormality detection unit detects the abnormality in the estimated self-position of the vehicle by comparing the amount of change in the estimated self-position and an estimated amount of movement of the vehicle obtained from the amount of lateral movement and the amount of longitudinal movement.

2. The abnormality diagnosis device according to claim 1, wherein:
the first movement amount calculation unit calculates the amount of movement of the vehicle based on the output of the LiDAR and an output of an IMU provided in the vehicle; and
the second movement amount calculation unit calculates the amount of movement of the vehicle based on the output of the camera and the output of the IMU.

3. The abnormality diagnosis device according to claim 1, wherein:
the first movement amount calculation unit calculates the amount of lateral movement and the amount of longitudinal movement; and
the abnormality detection unit detects the abnormality by comparing the amount of change in the estimated self-position and an estimated amount of movement of the vehicle obtained from the amount of lateral movement calculated by the first movement amount calculation unit and the amount of longitudinal movement calculated by the second movement amount calculation unit when the amount of longitudinal movement calculated by the first movement amount calculation unit is less than a predetermined value, and detects the abnormality by comparing the amount of change in the estimated self-position and an estimated amount of movement of the vehicle obtained from the amount of lateral movement and the amount of longitudinal movement calculated by the first movement amount calculation unit when the amount of longitudinal movement calculated by the first movement amount calculation unit is equal to or more than the predetermined value.

4. An abnormality diagnosis method executed by a computer, the abnormality diagnosis method comprising:
calculating an amount of change in an estimated self-position of a vehicle based on an output of a GNSS receiver provided in the vehicle;
calculating an amount of lateral movement of the vehicle based on an output of a LiDAR provided in the vehicle;
calculating an amount of longitudinal movement of the vehicle based on an output of a camera provided in the vehicle; and
detecting an abnormality in the estimated self-position of the vehicle by comparing the amount of change in the estimated self-position and an estimated amount of movement of the vehicle obtained from the amount of lateral movement and the amount of longitudinal movement.

5. A non-transitory storage medium storing a computer program causing a computer to execute a process comprising:
calculating an amount of change in an estimated self-position of a vehicle based on an output of a GNSS receiver provided in the vehicle;
calculating an amount of lateral movement of the vehicle based on an output of a LiDAR provided in the vehicle;
calculating an amount of longitudinal movement of the vehicle based on an output of a camera provided in the vehicle; and
detecting an abnormality in the estimated self-position of the vehicle by comparing the amount of change in the estimated self-position and an estimated amount of movement of the vehicle obtained from the amount of lateral movement and the amount of longitudinal movement.
